(19) United States
(12) Patent Application Publication
(10) Pub. No.: US 2026/0079293 A1
(43) Pub. Date: Mar. 19, 2026

(54) AMORPHOUS FLUORINATED POLYIMIDE OPTICAL-FIBER COATING

(71) Applicant: Nufern, East Granby, CT (US)

(72) Inventor: Ian MARTIN, West Hartford, CT (US)

(73) Assignee: Nufern, East Granby, CT (US)

(21) Appl. No.: 18/888,746

(22) Filed: Sep. 18, 2024

(51) Int. Cl. G02B 6/122; G02B 1/04; G02B 6/12

(52) U.S. Cl. CPC G02B 6/1221; G02B 1/046; G02B 1/048; G02B 2006/12076

(57) ABSTRACT

An optical fiber includes a glass structure to guide light along a longitudinal axis of the optical fiber, and an amorphous coating disposed on and surrounding the glass structure. The amorphous coating includes at least one fluorinated polyimide. A repeating unit each fluorinated polyimide includes two imide groups and at least one fluorinated aliphatic spacer group. Each imide group is attached to a terminus of a fluorinated aromatic group. The amorphous coating has a low refractive index, high-temperature stability, and low optical absorption, making the optical fiber suitable for high-power applications subject to high temperatures. The amorphous quality of the coating is compatible with fiber drawing and provides the necessary mechanical strength for the optical fiber when in use.

### TECHNICAL FIELD OF THE INVENTION

The present invention relates in general to optical fibers and optical-fiber coatings. The present invention relates in particular to amorphous optical-fiber coatings that have a low refractive index and exhibit both high-temperature stability and low optical absorption.

### DISCUSSION OF BACKGROUND ART

Optical fibers are used to transport laser light for a wide range of purposes, including telecommunications, sensing, and laser processing of materials. Optical fibers are also used as the gain medium in fiber lasers and fiber amplifiers. A typical optical fiber includes a glass core surrounded by a glass cladding. The glass core has a higher refractive index than the glass cladding, whereby light propagation can be confined to the core through the mechanism of total internal reflection. It is also possible for light to propagate in a hollow core of the optical fiber. In such hollow-core fibers, a structured glass cladding is designed to confine light propagation to the hollow core through the photonic bandgap effect or through anti-resonance. The structured cladding is supported by a surrounding glass tube.

It is common that optical fibers, whether configured with a solid or hollow core, are coated with one or more (typically two) protective polymer layers. In so-called double-clad fibers, the polymer coating disposed directly on the primary glass cladding has a lower refractive index than the primary glass cladding. This polymer coating thereby serves as a secondary cladding that provides optical confinement for light propagating in the primary glass cladding.

The process of applying a polymer coating to an optical fiber is integrated in the fiber manufacturing process. The manufacturing process takes place on a draw tower, where a glass preform is transformed into a long, thin fiber with precise dimensions and properties. The preform is heated in a furnace at the top of the tower. As the preform softens, the glass material is drawn downward to form the long, thin fiber. Further down the tower, the bare fiber passes through a one or more coating applicators. Each coating applicator applies a polymer coating. The fiber with uncured polymer coating is drawn further downward and then cured. Curing of the polymer coating may be performed by heating or with UV radiation.

The polymer coatings provide protection against environmental factors such as moisture and chemical contaminants. The polymer coatings also provide mechanical resilience against abrasion, bending, and general handling of the optical fiber. Key performance parameters of the coatings include elasticity/hardness, temperature stability, UV resistance, viscosity, curing speed, adhesion properties, resistance to delamination, ease of removal (stripping) for termination/splicing, micro-bending performance, and abrasion resistance. In applications where a polymer coating layer serves as a secondary cladding, relevant optical performance parameters include the refractive index and optical absorption properties.

Acrylate coatings are widely used, particularly for telecommunication fibers, due to their low cost and ease of removal for termination. Acrylate coatings are often applied in two layers to reduce micro-bending loss, with the inner layer being softer than the outer layer. Standard acrylate coatings have a maximum temperature rating of around 80° C., though high-temperature versions can withstand up to 150° C. or more. Silicone coatings are also relatively common and offer improved temperature stability, withstanding temperatures up to about 200° C. However, silicone coatings are tacky and relatively difficult to strip cleanly, therefore often requiring an additional jacket layer. The temperature limit of the fiber is often determined by this jacket material rather than the silicone. On the other hand, silicone coatings help reduce micro-bending loss and can be used as a cladding material in some applications.

Polyimide coatings offer significantly better temperature stability than both acrylate and silicone. A polyimide is a polymer with a repeating unit that includes one or more imide groups. An imide group is a functional group having a nitrogen atom bonded to two carbon atoms, with each of these carbon atoms being double bonded to a respective oxygen atom. Polyimide coatings can tolerate continuous use in temperatures from below 65° C. up to 300° C., with temporary excursions up to 400° C. possible. Polyimide coatings also exhibit good chemical resistance. In general, the choice of coating material significantly influences the suitability of an optical fiber for different applications and environments. Thus, different applications and environments may require or benefit from different types of coating materials.

### SUMMARY OF THE INVENTION

High-power applications of optical fibers impose specific requirements to the polymer coating material used for the optical fiber. When the laser power is high, leakage of laser light from the core and cladding into the immediately surrounding polymer coating can have detrimental effects. Leakage can be minimized by choosing a coating material that has a significantly lower refractive index than the cladding. In the event that leakage does occur, the biggest potential issue is heat-induced damage to the polymer coating caused by absorption of the leaked laser light. This issue can be mitigated by choosing a coating material that exhibits low optical absorption. Tolerance to high temperatures is also helpful for reducing the risk of heat-induced damage to the polymer coating. Thus, a coating material characterized by a low refractive index, low optical absorption, and high-temperature stability is preferable in high-power applications. A requirement for high-temperature stability may also be imposed by the operating environment. Certain high-power applications, such as downhole sensing, take place in harsh environments that expose the optical fiber to high temperatures.

Commonly used coating materials, such as acrylate and silicone, do not meet the specific combination of requirements presented by high-power applications subject to high environmental temperatures, namely low refractive index, low optical absorption, and high-temperature stability. While conventional polyimide coatings exhibit excellent high-temperature stability, their refractive index is higher than that of a silica glass cladding. Additionally, many polyimide materials exhibit strong optical absorption in the near- and mid-infrared spectral ranges, thus limiting their usefulness.

Many fluorinated polymers have a low refractive index and exhibit lower optical absorption than their non-fluorinated counterparts. However, achieving the right combination of optical, thermal, and mechanical properties is challenging. For example, some fluorinated polymers with acceptable optical properties have poor temperature stability. Other fluorinated polymers with desirable optical properties produce coatings that suffer from high crystallinity. The high crystallinity compromises the mechanical strength of the cured coated optical fiber, presenting risks of damage or breakage during both the fiber drawing process and subsequent handling and use of the optical fiber.

Disclosed herein is an amorphous fluorinated polyimide optical-fiber coating that overcomes these challenges. The present coating has a low refractive index, high-temperature stability, and low optical absorption. At the same time, its amorphous quality is compatible with fiber drawing and provides the necessary mechanical strength for the optical fiber when in use. The coating is based on a fluorinated polyimide with a repeating unit that includes (a) two imide groups each attached to a fluorinated aromatic group and (b) one or more fluorinated aliphatic spacer groups. The imide groups may be attached to the same fluorinated aromatic group or two separate fluorinated aromatic groups. The aliphatic spacer groups ensure that the coating is amorphous rather than crystalline. Fluorination reduces optical absorption by eliminating C—H bonds that would otherwise absorb strongly in portions of the optical spectrum. Preferably, the polymer is fully fluorinated. However, a relatively minor presence of C—H bonds, versus C—F bonds, may be acceptable in some applications. The repeating unit may include additional aromatic groups, not necessarily with imide groups attached thereto. Such additional aromatic groups may further improve high-temperature stability and further reduce the refractive index.

Thermal stability above 300° C., degradation temperatures exceeding 400° C., high transparency in the infrared spectral region up to 2.0 micrometers (μm), and a refractive index significantly lower than silica glass, have been demonstrated with the presently disclosed amorphous fluorinated polyimide optical-fiber coating, thus enabling its use in high-power laser applications and harsh environments.

In one aspect of the invention, an optical fiber includes a glass structure to guide light along a longitudinal axis of the optical fiber, and an amorphous coating disposed on and surrounding the glass structure. The amorphous coating includes at least one fluorinated polyimide. A repeating unit of each of the at least one fluorinated polyimide includes two imide groups and at least one fluorinated aliphatic spacer group. Each of the two imide groups is attached to a terminus of a fluorinated aromatic group.

In another aspect of the invention, a chemical mixture for forming an amorphous coating on an optical fiber includes at least one fluorinated polyimide. A repeating unit of each of the at least one fluorinated polyimide includes two imide groups and at least one fluorinated aliphatic spacer group. Each of the two imide groups is attached to a terminus of a fluorinated aromatic group. The chemical mixture further includes an adhesion promoter, a thermal stabilizer, and a solvent.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIGS. 1A and 1B illustrate an optical fiber with an amorphous fluorinated polyimide coating, according to an embodiment.

FIG. 2 schematically illustrates one exemplary fluorinated polyimide repeating unit, upon which the amorphous fluorinated polyimide coating of the optical fiber of FIGS. 1A and 1B may be based.

FIG. 3 schematically illustrates another exemplary fluorinated polyimide repeating unit, upon which the amorphous fluorinated polyimide coating of the optical fiber of FIGS. 1A and 1B may be based.

FIG. 4 illustrates one dual-clad optical fiber with an amorphous fluorinated polyimide coating, according to an embodiment.

FIG. 5 illustrates another dual-clad optical fiber with an amorphous fluorinated polyimide coating, according to an embodiment.

FIG. 6 illustrates a “coreless” optical fiber with an amorphous fluorinated polyimide coating, according to an embodiment.

FIG. 7 illustrates a hollow-core optical fiber with an amorphous fluorinated polyimide coating, according to an embodiment.

### DETAILED DESCRIPTION OF THE INVENTION

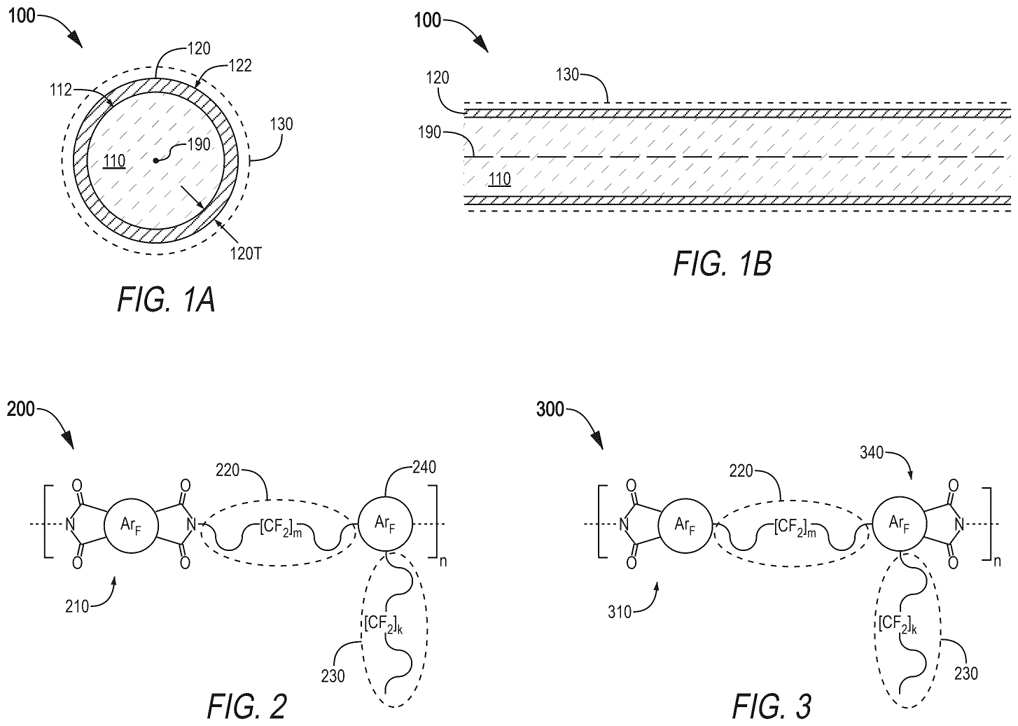

Referring now to the drawings, wherein like components are designated by like numerals, FIGS. 1A and 1B are orthogonal cross-sectional views of one optical fiber 100 with an amorphous fluorinated polyimide (AFP) coating 120. The cross section depicted in FIG. 1A is orthogonal to a longitudinal axis 190 of fiber 100. FIG. 1B depicts a longitudinal segment of fiber 100, with the cross section including longitudinal axis 190.

Herein, the term “amorphous” does not rule out a small degree of crystallinity. An “amorphous” coating, as referred to herein, is a coating that is less than 10% crystalline, for example as measured by differential scanning calorimetry. Thus, the crystallinity of AFP coating 120 may be in the range between 0% and 10%. Preferably, the crystallinity of AFP coating 120 is no more than 2%.

Herein, the term “polyimide” refers to a type of polymer characterized by its repeating unit including one or more imide groups, and the term “imide group” refers to a functional group having a nitrogen atom, two carbon atoms, and two oxygen atoms, wherein the nitrogen atom is bonded between the carbon atoms, and each carbon atom is double-bonded to a respective one of the oxygen atoms.

Fiber 100 includes a glass structure 110 and AFP coating 120. Glass structure 110 is configured to guide light propagation through fiber 100 in the longitudinal direction. Glass structure 110 may have a solid core or a hollow core. The glass of glass structure 110 may be made of, or include, silica.

AFP coating 120 is deposited on an outer surface 112 of glass structure 110. Outer surface 112 surrounds longitudinal axis 190 and faces radially-outward with respect to longitudinal axis 190. AFP coating 120 includes one or more fluorinated polyimides. In addition, AFP coating 120 may include an adhesion promoter and/or a thermal stabilizer. The adhesion promoter aids adhesion of AFP coating 120 to outer surface 112. The adhesion promoter may include a silane-based compound. The thermal stabilizer inhibits oxidation of AFP coating 120 under thermal stress, and may include a phenolic hydroxyl group and alkyl groups attached to an aromatic ring. The fluorinated polyimide may constitute at least 15 weight percent (wt %) of AFP coating 120 to achieve a viscosity suitable for coating application during the fiber drawing process.

The repeating unit of each fluorinated polyimide of AFP coating 120 includes (a) at least two imide groups and (b) at least one fluorinated aliphatic spacer group. Each of the imide groups is attached to a terminus of a fluorinated aromatic group. The imide groups may be attached to the same fluorinated aromatic group or to separate fluorinated aromatic groups. The aromatic group(s) with attached imide groups improve the high-temperature stability of AFP coating 120. The fluorination of AFP coating 120 results in a lower refractive index and less optical absorption than exhibited by similar non-fluorinated polyimide coatings. The fluorinated aliphatic spacer group reduces rigidity of the repeating unit sufficiently to render AFP coating 120 amorphous. The amorphous quality of AFP coating 120 makes it possible to apply AFP coating 120 to glass structure 110 in a draw tower used to manufacture glass structure 110. The amorphous quality of AFP coating 120 also adds mechanical protection during the manufacture of fiber 100 as well as during subsequent handling and use of fiber 100. The thickness 120 T of AFP coating 120 may be in the range between 5 and 30 μm.

Carbon-hydrogen (C—H) bonds have higher vibrational energies than carbon-fluorine (C—F) bonds. C—H bonds therefore have stronger absorption bands in the near- and mid-infrared spectral regions and the fluorinated polyimide of AFP coating 120 is preferably fully fluorinated. Presence of C—H bonds will introduce some optical absorption and may also increase the refractive index of AFP coating 120. However, depending on the application, a minor presence of C—H bonds may be acceptable. In one embodiment with only partial fluorination, the molar ratio of C—F to C—H bonds is at least 9:1 for the fluorinated polyimide of AFP coating 120.

The repeating unit of the fluorinated polyimide of AFP coating 120 may also include additional fluorinated aromatic groups with no imide groups attached thereto. Such additional fluorinated aromatic groups may further improve the high-temperature stability of AFP coating 120 and/or further reduce the refractive index.

The refractive index of AFP coating 120 may be less than 1.35 throughout the wavelength range between 1 and 2 μm. In one embodiment, the refractive index of AFP coating 120 is significantly less than the refractive indices of most glasses commonly used for optical fibers, such as silica, throughout the wavelength range between 1 and 2 μm. Thus, without having to resort to exotic types of glass, the glass material of the portion of glass structure 110 in direct contact with AFP coating 120 may be chosen to produce a significant refractive-index contrast therebetween. In one embodiment, at least this portion of glass structure 110 is made of silica. A significant refractive-index contrast between AFP coating 120 and the portion of glass structure 110 in direct contact therewith provides optical confinement through the mechanism of total internal reflection. The low refractive index of AFP coating 120 thereby helps prevent light leakage from glass structure 110 into AFP coating 120.

The optical absorption of AFP coating 120 may be similar to that of silica throughout the wavelength range between 1 and 2 μm, whereby light leakage from glass structure 110 into AFP coating 120 presents a relatively low heat load on AFP coating 120. In one embodiment, the absorptivity of AFP coating 120, as measured along the length of fiber 100, is at most 5 decibel/kilometer (dB/km) at the wavelength of 1185 nanometers (nm). This wavelength is a known absorption band for C—H bonds.

The low refractive index and the low optical absorption of AFP coating 120 make fiber 100 suitable for high-power applications. The excellent high-temperature stability of AFP coating 120 further adds to this quality. The high-temperature stability of AFP coating 120 also makes fiber 100 suitable for use in harsh environments where high temperatures may be encountered. In one application, fiber 100 is used to transport laser light with an average power of up to about 10 kilowatts (kW). In another application, glass structure 110 of fiber 100 includes a gain medium wherein the average laser power reaches, e.g., 1 kW or more.

FIG. 2 schematically illustrates one fluorinated polyimide repeating unit 200, upon which AFP coating 120 may be based. Repeating unit 200 includes a fluorinated aromatic diimide 210 and at least one fluorinated aliphatic spacer group 220. Each fluorinated spacer group 220 forms part of the backbone of repeating unit 200 to most effectively reduce the rigidity thereof. Reduced rigidity of repeating unit 200 results in embodiments of AFP coating 120 based on repeating unit 200 being amorphous. In one embodiment, the repeating unit 200 includes at least one fluorinated backbone spacer group 220 (one is depicted in FIG. 2). Each fluorinated backbone spacer group 220 may include a CF₂ (difluoromethylene) group or a chain of CF₂ groups, for example up to ten CF₂ groups. Repeating unit 200 may become progressively less rigid as the number of CF₂ groups in backbone spacer group 220 is increased from one. Thus, it may be advantageous for backbone spacer group 220 to include a plurality of CF₂ groups, e.g., between 2 and 10 CF₂ groups.

Certain embodiments of repeating unit 200 include both fluorinated backbone spacer group(s) 220 and at least one additional fluorinated aliphatic spacer group 230 situated in a side-arm off the backbone. Each fluorinated side-arm spacer group 230 may be terminated with a CF₃ (trifluoromethyl) group but is otherwise similar to fluorinated backbone spacer group 220. Fluorinated side-arm spacer group(s) 230 may further reduce the rigidity of repeating unit 200. Without departing from the scope hereof, repeating unit 200 may omit fluorinated backbone spacer group 220 and rely solely on fluorinated side-arm spacer group(s) 230 to render associated embodiments of AFP coating 120 amorphous.

Preferably, fluorinated aromatic diimide 210 forms part of the backbone of repeating unit 200. Positioning of fluorinated aromatic diimide 210 in the backbone may prevent leaching of fluorinated aromatic diimide 210 out of AFP coating 120.

Repeating unit 200 may include one or more additional fluorinated aromatic groups 240 that have no imide groups attached thereto. Fluorinated aromatic groups 240 may improve the high-temperature stability of embodiments of AFP coating 120 comprising repeating unit 200. Fluorinated aromatic groups 240 may also lead to a reduction in the refractive index of embodiments of AFP coating 120 based on repeating unit 200. Embodiments of repeating unit 200 may include additional fluorinated backbone spacer groups 220 interspersed between additional fluorinated aromatic groups 240.

In the example depicted in FIG. 2, optional fluorinated side-arm spacer group 230 is attached to an optional fluorinated aromatic group 240. Alternatively or in combination therewith, repeating unit 200 may include one or more fluorinated side-arm spacer groups 230 attached elsewhere, for example to fluorinated aromatic diimide 210. Embodiments of repeating unit 200 that include a plurality of fluorinated aromatic groups 240 may include a plurality of side-arm spacer group 230, each attached to a different one of the fluorinated aromatic groups 240.

In embodiments of AFP coating 120 based on repeating unit 200, the number of repeating units, n, in the fluorinated polyimide may be in the range between 2 and 100 for the majority of the fluorinated polyimide in the coating. The average number of repeating units 200 may be in the range between 20 and 70, with the average being an average over the full volume of the coating.

In FIG. 2, each circle labeled “Ar_{F}” indicates a fully fluorinated aromatic group that includes one or more aromatic rings. Examples of fluorinated aromatic diimide 210 include those represented by the chemical formulas (1) through (4), wherein the dashed lines indicate chemical bonds to other parts of repeating unit 200:

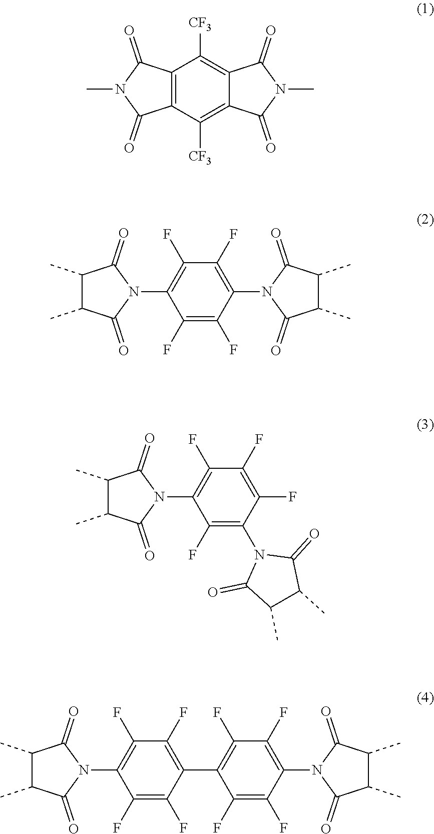

Examples of fluorinated aromatic group 240 include those represented by the chemical formulas (5) and (6):

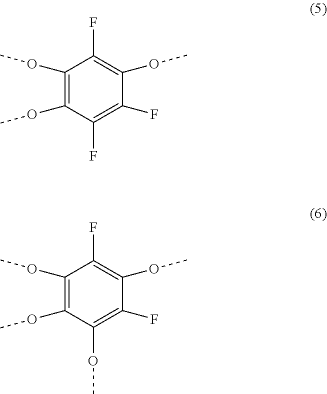

In each of chemical formulas (1) through (6), one or more of the fluorine atoms indicated may be replaced by a fluorinated functional group. Furthermore, while each of chemical formulas (1) through (6) has full fluorination, partial fluorination may be acceptable in some applications, as discussed above in reference to FIG. 1.

Repeating unit 200 may take many different forms, for example based on various combinations of the compounds represented by chemical formulas (1) through (6). A few select examples of repeating unit 200 are represented by the chemical formulas (7) and (8):

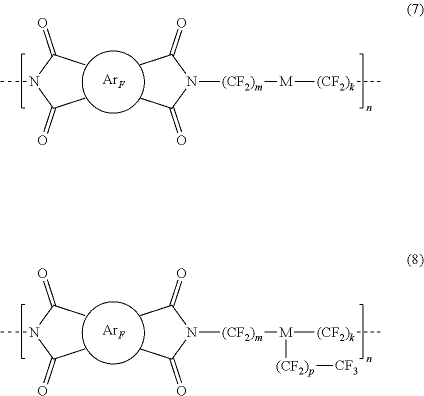

In each of chemical formulas (7) and (8), the circled “Ar_{F}” indicates a fully fluorinated aromatic group that includes one or more aromatic rings, and “M” is a fully fluorinated monomer (aromatic or aliphatic). Each of integers m, k, and p may be in the range between 1 and 10. In certain embodiments, p is zero, corresponding to the side-arm spacer group consisting of a single CF₃ group.

Comparing the structured fluorinated polyimides represented by the series of chemical formulas (7) and (8), chemical formula (8) has a higher number of spacer groups. The repeating unit of chemical formula (7) includes two fluorinated backbone spacer groups 220. The repeating unit of chemical formula (8) adds a fluorinated side-arm spacer group 230 attached to a backbone monomer. The increased number of fluorinated spacer groups in chemical formula (8) is expected to decrease the rigidity of the fluorinated polyimide, thus decreasing the crystallinity of associated embodiments of AFP coating 120 when cured.

Full fluorination, as indicated in chemical formulas (7) and (8), is preferable. However, a minor presence of non-substituted C—H bonds may be acceptable in some applications, as discussed above in reference to FIG. 1.

FIG. 3 schematically illustrates another fluorinated polyimide repeating unit 300, upon which AFP coating 120 may be based. Repeating unit 300 is similar to repeating unit 200, except that the two imide groups incorporated in fluorinated aromatic diimide 210 of repeating unit 200 are located on two separate fluorinated aromatic groups in repeating unit 300. Thus, instead of fluorinated aromatic diimide 210, repeating unit 300 includes two aromatic imides 310 and 340 separated from each other by a fluorinated backbone spacer group 220. Although not shown in FIG. 3, repeating unit 300 may further include one or more additional fluorinated aromatic groups 240 with no imide groups attached thereto.

In one example, each of aromatic imides 310 and 340 is of the form:

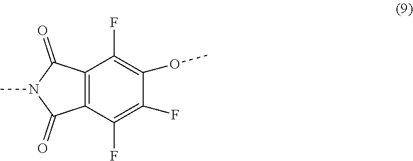

One or more of the fluorine atoms indicated in chemical formula (9) may be replaced by a fluorinated functional group. Furthermore, although full fluorination is preferable, partial fluorination may be acceptable in some applications, as discussed above in reference to FIG. 1. For example, one fluorine atom in chemical formula (9) may be replaced by a hydrogen atom.

Either one of repeating units 200 and 300 may include more imide groups, each attached to a fluorinated aromatic group 210/310/340. Either repeating unit 200 and 300 may also include more aromatic imide groups than depicted in FIGS. 2 and 3 and more than indicated in chemical formulas (7) and (8). In addition, repeating units 200 and 300 may include one or more fluorinated aliphatic or aromatic monomers not depicted in FIGS. 2 and 3 nor indicated in chemical formulas (7) and (8). Furthermore, at least one fluorinated backbone spacer group 220 may be situated at an end of either one of repeating units 200 and 300, for example as is the case for the repeating units represented by chemical formulas (7) and (8).

Referring again to FIGS. 1A and 1B, AFP coating 120 may include multiple fluorinated polyimides with different repeating units, for example selected from the repeating units discussed above in reference to FIGS. 2 and 3. With respect to manufacturing simplicity, it may be advantageous if AFP coating 120 is based on a single fluorinated polyimide. However, the use of two or more different fluorinated polyimides may allow for further optimization of the properties of AFP coating 120.

Certain embodiments of fiber 100 further include an additional polymer coating 130 disposed on an outer surface 122 of AFP coating 120. Polymer coating 130 may add abrasion resistance. To fully take advantage of the high-temperature stability of AFP coating 120, polymer coating 130 preferably exhibits high-temperature stability similar to or better than that of AFP coating 120. However, polymer coating 130 does not need to have as low a refractive index as AFP coating 120. In one embodiment, polymer coating 130 is an amorphous non-fluorinated polyimide coating, or an amorphous partially-fluorinated polyimide coating that is less fluorinated than the fluorinated polyimide(s) of AFP coating 120.

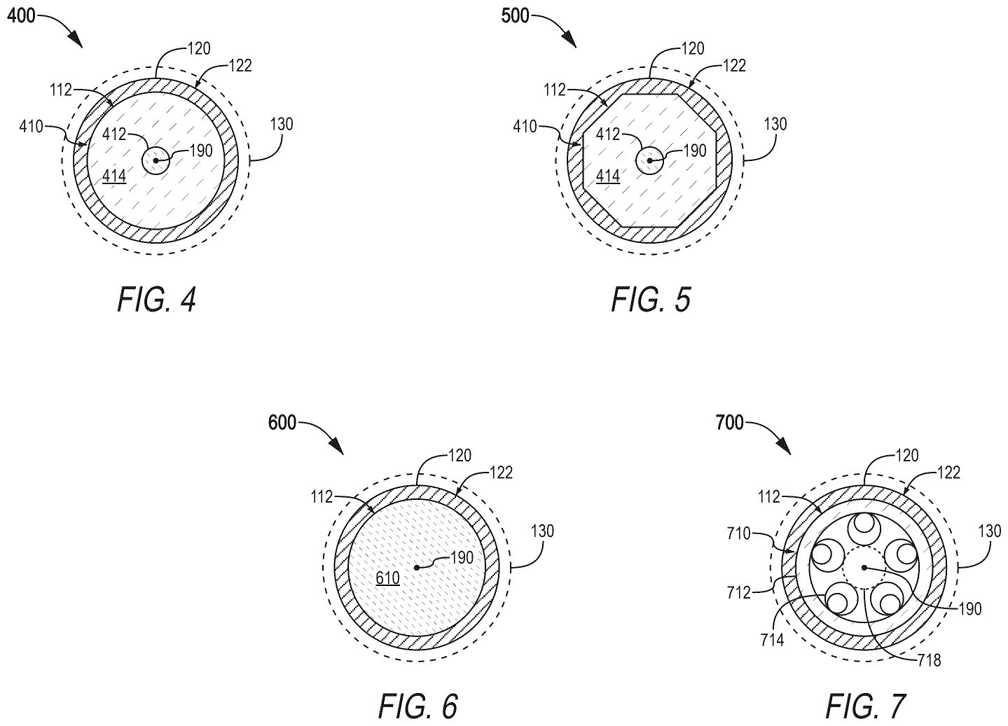

AFP coating 120 may be implemented in many different types of optical fibers configured with different respective embodiments of glass structure 110. FIGS. 4-7 depict exemplary optical fibers that include AFP coating 120. Each of the optical fibers of FIGS. 4-7 is an embodiment of fiber 100.

FIG. 4 is a cross-sectional view of one dual-clad optical fiber 400 that implements AFP coating 120. In dual-clad fiber 400, glass structure 110 is implemented as a glass structure 410 that includes a central glass core 412 and a surrounding glass cladding 414. Glass cladding 414 forms outer surface 112 upon which AFP coating 120 is deposited. Glass core 412 has a higher refractive index than glass cladding 414, and glass cladding 414 has a higher refractive index than AFP coating 120. Each of glass core 412 and glass cladding 414 may be made of silica, but with doping properties differing between glass core 412 and glass cladding 414 to produce the refractive-index contrast therebetween.

In one application, dual-clad fiber 400 is used as a transport fiber for high-power laser light. In this application, the refractive-index contrast between glass core 412 and glass cladding 414 serves to guide the laser light in glass core 412. However, various non-idealities may cause some laser light to leak into glass cladding 414. AFP coating 120 functions as a secondary cladding, such that at least some of the leaked laser light is guided in the combined volume of glass core 412 and glass cladding 414 through the mechanism of total internal reflection.

In another application, glass core 412 is a gain medium in a fiber laser or fiber amplifier. In this application, glass core 412 is doped with a rare-earth element to provide laser gain. Pump laser light, used to excite the rare-earth element in glass core 412, is guided in the combined volume of glass core 412 and glass cladding 414 by virtue of the refractive-index contrast between glass cladding 414 and AFP coating 120. The pump laser light may be near-infrared.

FIG. 5 is a cross-sectional view of another dual-clad optical fiber 500 that implements AFP coating 120. Dual-clad fiber 500 is similar to dual-clad fiber 400 except that outer surface 112 of glass cladding 414 in dual-clad fiber 500 has a non-circular cross section. In the depicted example, the cross section of outer surface 112 is octagonal. Hexagonal and other non-circular shapes are possible as well. These non-circular shapes may improve spatial overlap between glass core 412 and laser light coupled into glass cladding 414 by discouraging propagation of skew rays that have poor overlap with glass core 412. In a typical coating process, a die ensures that the outer surface 122 of AFP coating 120 has a circular cross section despite the cross section of outer surface 112 not being circular.

FIG. 6 is a cross-sectional view of one so-called coreless optical fiber 600 that implements AFP coating 120. In coreless fiber 600, glass structure 110 is implemented as a glass fiber 610 of uniform composition and thus uniform refractive index. Glass fiber 610 forms outer surface 112, upon which AFP coating 120 is deposited. The refractive index of glass fiber 610 is less than the refractive index of AFP coating 120. AFP coating 120 therefore functions as a cladding to guide laser light in glass fiber 610.

FIG. 7 illustrates one hollow-core optical fiber 700 that implements AFP coating 120. Hollow-core fiber 700 implements glass structure 110 as a glass structure 710 that includes (a) a glass tube 712 and (b) glass cladding elements 714 forming a structured glass cladding. Cladding elements 714 are located in the hollow interior of glass tube 712 and supported by glass tube 712. Cladding elements 714 define a hollow core 718, schematically indicated by a dashed outline in FIG. 7. Cladding elements 714 are configured to guide light in hollow core 718.

In the depicted example, hollow-core fiber 700 is a nested anti-resonance nodeless fiber (NANF), wherein cladding elements 714 include sets of nested tubes distributed about longitudinal axis 190. Other types of structured claddings, configured with other types of cladding elements 714, are possible. More generally, the structured cladding of hollow-core fiber 700 is configured to guide light in hollow core 718 through either anti-resonance or the photonic bandgap effect.

Referring again to FIG. 1, the production of AFP coating 120 during manufacturing of optical fiber 100 includes depositing a chemical mixture on outer surface 112 of glass structure 110. This chemical mixture includes the fluorinated polyimide, adhesion promoter, and thermal stabilizer discussed above in reference to AFP coating 120 and fluorinated polyimide repeating units 200 and 300. In addition, the chemical mixture includes a solvent. The majority of the solvent, e.g., at least 99% by weight, is likely to evaporate during curing of the chemical mixture to form AFP coating 120. However, some of the solvent may remain in AFP coating 120. Therefore, in order to maintain low optical absorption, the solvent may be fluorinated, preferably fully fluorinated. Furthermore, full fluorination improves the ability of the solvent to solubilize the fluorinated polyimide of AFP coating 120. In one embodiment, the fluorinated polyimide constitutes between 10 and 50 wt % of the mixture, the adhesion promotor constitutes between 0.5 and 5 wt % of the mixture, the thermal stabilizer constitutes between 0.1 and 2 wt % of the mixture, and the solvent constitutes between 40 and 90% of the mixture.

The present invention is described above in terms of a preferred embodiment and other embodiments. The invention is not limited, however, to the embodiments described and depicted herein. Rather, the invention is limited only by the claims appended hereto.

What is claimed is:

1. An optical fiber, comprising:
a glass structure to guide light along a longitudinal axis of the optical fiber; and
an amorphous coating disposed on and surrounding the glass structure, the amorphous coating including at least one fluorinated polyimide, a repeating unit of each of the at least one fluorinated polyimide including:
two imide groups, each of the two imide groups attached to a terminus of a fluorinated aromatic group, and
at least one fluorinated aliphatic spacer group.

2. The optical fiber of claim 1, wherein the repeating unit further includes an additional fluorinated aromatic group.

3. The optical fiber of claim 1, wherein each of the at least one fluorinated polyimide is fully fluorinated.

4. The optical fiber of claim 1, wherein a molar ratio of C—F bonds to C—H bonds is at least 9:1 for each of the at least one fluorinated polyimide.

5. The optical fiber of claim 1, wherein the at least one fluorinated polyimide constitutes at least 15 weight percent of the amorphous coating.

6. The optical fiber of claim 1, wherein a backbone of each of the at least one fluorinated polyimide includes at least one fluorinated aliphatic spacer group within the repeating unit.

7. The optical fiber of claim 6, wherein the repeating unit further includes at least one other fluorinated aliphatic spacer group that is not located on the backbone.

8. The optical fiber of claim 1, wherein each of the at least one fluorinated aliphatic spacer group includes a difluoromethylene group.

9. The optical fiber of claim 1, wherein each of the at least one fluorinated aliphatic spacer group includes at least one difluoromethylene group in a backbone of the fluorinated polyimide.

10. The optical fiber of claim 1, wherein each of the at least one fluorinated aliphatic spacer group includes a chain of difluoromethylene groups attached to each other along a backbone of the fluorinated polyimide.

11. The optical fiber of claim 10, wherein the chain of difluoromethylene groups includes between 2 and 10 difluoromethylene groups.

12. The optical fiber of claim 1, wherein the two imide groups are attached to the same fluorinated aromatic group.

13. The optical fiber of claim 1, wherein the two imide groups are attached to the same fluorinated aromatic ring.

14. The optical fiber of claim 1, wherein the two imide groups are attached to two respective fluorinated aromatic groups separated from each other by at least one fluorinated aliphatic spacer group.

15. The optical fiber of claim 1, wherein the amorphous coating further includes an adhesion promoter and a thermal stabilizer.

16. The optical fiber of claim 1, wherein the amorphous coating has a lower refractive index than a portion of the glass structure in direct contact with the amorphous coating.

17. The optical fiber of claim 1, wherein a refractive index of the amorphous coating is less than 1.35 throughout a wavelength range from 1 to 2 micrometers.

18. The optical fiber of claim 1, wherein the glass structure includes:
a solid glass core; and
a solid glass cladding surrounding and having (a) a lower refractive index than the solid glass core and (b) a higher refractive index than the amorphous coating, the amorphous coating being deposited on the solid glass cladding.

19. The optical fiber of claim 1, wherein the glass structure includes:
a hollow glass tube, the amorphous coating being deposited on a radially-outward facing surface of the hollow glass tube; and
a plurality of glass cladding elements (a) distributed about the longitudinal axis of the optical fiber to surround and define a hollow core thereof, (b) positioned inside the hollow glass tube, and (c) connected to and supported by the hollow glass tube.

20. A chemical mixture for forming an amorphous coating on an optical fiber, comprising:
at least one fluorinated polyimide, a repeating unit of each of the at least one fluorinated polyimide including:
two imide groups, each of the two imide groups attached to a terminus of a fluorinated aromatic group, and
at least one fluorinated aliphatic spacer group;
an adhesion promoter;
a thermal stabilizer; and
a solvent.

21. The chemical mixture of claim 20, wherein the solvent is fluorinated.

22. The chemical mixture of claim 20, wherein the solvent is fully fluorinated.

23. The chemical mixture of claim 20, wherein the fluorinated polyimide constitutes between 10 and 50 weight % of the chemical mixture, the adhesion promotor constitutes between 0.5 and 5 weight % of the chemical mixture, the thermal stabilizer constitutes between 0.1 and 2 weight % of the chemical mixture, and the solvent constitutes between 40 and 90 weight % of the chemical mixture.
